(19) United States
(12) Patent Application Publication
(10) Pub. No.: US 2011/0052313 A1
(43) Pub. Date: Mar. 3, 2011

(54) BIAXIAL JOINT

(76) Inventors: Ivan Boruta, Frycovice (CZ); Petr Mil, Frydek-Mistek (CZ); Rene Fabriger, Pribor (CZ)

(21) Appl. No.: 12/063,105

(22) PCT Filed: Jun. 7, 2007
(86) PCT No.: PCT/CZ2007/000046

§ 371 Date: Feb. 15, 2008

(30) Foreign Application Priority Data
Jun. 8, 2006 (CZ) PUV 2006-17814

(51) Int. Cl. F16C 11/04

(52) U.S. Cl. 403/119

(57) ABSTRACT

The body of the joint (2) is pivotally seated on the central pin (1), onto which is also fitted the wheel (3) with a screw (4) and internal toothing (5), while in the body of the joint (2) is in the guide (8) a movably seated sliding block (7), into which is inserted the arresting pin (6), and on the body of the joint (2) is pivotally fitted the collar of the joint (9), which is pressed by a lever (10) with eccentric (11) over the casing (12), disc springs (13) and radial toothing (14) to the body of the joint (2), and it is connected by the central screw (15) to the sliding block (7), between which and the body of the joint (2) is inserted the internal expanding spring (16), while between the body of the joint (2) and the collar of the body (9) is inserted the external expanding spring (17), and the body of the joint (2) is covered with capping (18).

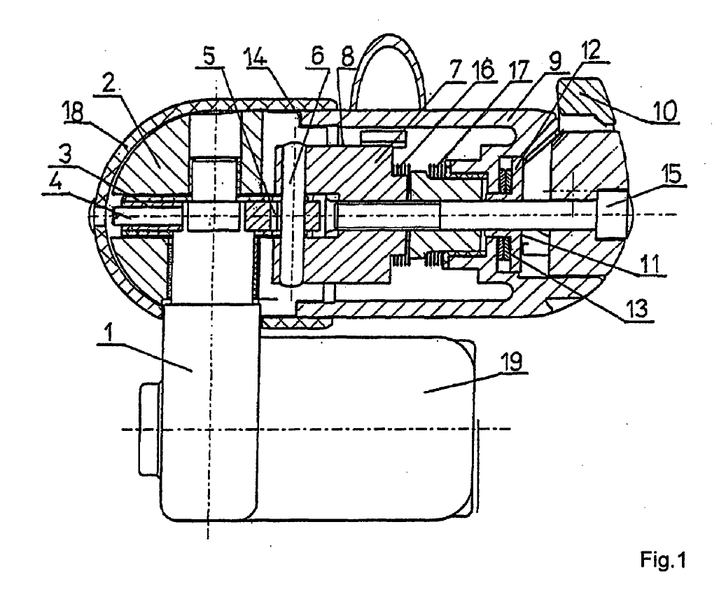

### TECHNICAL FIELD

The invention concerns biaxial joint for leg support used on birth beds and gynaecological examination chair.

### BACKGROUND ART

To set the required position for leg support used on birth beds or gynaecological examination chairs, either ball joints or various arresting devices are used. The disadvantage of the ball joint is its insufficient load-bearing capacity, while the arresting devices are characterised by their incompact shape, time-consuming setting process, and by their mostly difficult cleaning.

### DISCLOSURE OF THE INVENTION

The above indicated shortcomings are resolved to a large extent by the biaxial joint according to this invention, the essence of which consists of the following: the body of the joint is pivotally seated on the central pin, onto which is also fixed the wheel with a screw and internal toothing, while in the body of the joint is in the guide installed a sliding block, into which is fitted the arresting pin, and onto the body of the joint is pivotally installed the collar of the joint, pressed by a lever with eccentric over the casing, disc springs and radial toothing to the body of the joint, and it is connected by the central screw to the sliding block, between which and the body of the joint is inserted an internal expanding spring, while between the body of the joint and the collar of the joint is inserted the external expanding spring, and the body of the joint is covered with capping.

The advantage of the biaxial joint according to this invention rests in its capacity to allow very fast setting of leg support used on birth beds or gynaecological examination chairs for the given size of a patient.

### BRIEF DESCRIPTION OF THE DRAWING

The attached drawing schematically illustrates the biaxial joint according to this invention.

### MODE FOR CARRYING OUT THE INVENTION

An example of execution of biaxial joint made according to this invention is apparent from the attached example. On the central pin 1 is pivotally seated the body of the joint 2 and the wheel 3 with a screw 4 and internal toothing 5. In the body of the joint 2 is in the guide 8 movably seated the sliding block Jx into which is inserted the arresting pin 6. Onto the body of the joint 2 is pivotally fitted the collar of the joint 9, which is pressed by a lever 10 with eccentric H over the casing 12, disc springs 13 and radial toothing 14 to the body of the joint 2. The collar of the joint 9 is connected with the central screw 15 to the sliding block 7, between which and the body of the joint 2 is inserted the internal expanding spring 16. Between the body of the joint 2 and the collar of the joint 9 is inserted the external expanding spring 17. The body of the joint 2 is covered with capping 18. On the central pin 1 is fitted a control lever 19.

### INDUSTRIAL APPLICABILITY

The biaxial joint according to this invention can be utilised advantageously for leg support used on birth beds and on gynaecological examination chairs and for other health services equipment.

1. The biaxial joint, characterised in that the body of the joint (2) is pivotally seated on the central pin (1), onto which is also fitted the wheel (3) with a screw (4) and internal toothing (5), while in the body of the joint (2) is in the guide (8) a movably seated sliding block (7), into which is inserted the arresting pin (6), and on the body of the joint (2) is pivotally fitted the collar of the joint (9), which is pressed by a lever (10) with eccentric (11) over the casing (12), disc springs (13) and radial toothing (14) to the body of the joint (2), and it is connected by the central screw (15) to the sliding block (7), between which and the body of the joint (2) is inserted the internal expanding spring (16), while between the body of the joint (2) and the collar of the body (9) is inserted the external expanding spring (17), and the body of the joint (2) is covered with capping (18).
